(19) United States
(12) Patent Application Publication
(10) Pub. No.: US 2006/0006701 A1
(43) Pub. Date: Jan. 12, 2006

(54) SYSTEM AND METHOD FOR RAIN DETECTION AND AUTOMATIC OPERATION OF POWER ROOF AND POWER WINDOWS

(76) Inventor: Jason Wells, Somerdale, NJ (US)

Correspondence Address: SNELL & WILMER;ONE ARIZONA CENTER, 400 EAST VAN BUREN, PHOENIX, AZ, 850040001, US

(21) Appl. No.: 10/710,375

(22) Filed: Jul. 6, 2004

(51) Int. Cl. B60J 7/057

(52) U.S. Cl. 296/223

(57) ABSTRACT

The present invention comprises a system and method for protecting the interior of an automobile having at least a power roof or power windows. The method includes a damaging element detection sensor for detecting moisture or airborne particles which may damage the interior of the automobile by contacting the material when the automobile is left unattended with the automobile power roof or power windows in an open or lowered position. The damaging element detection sensor may be one of a moisture or particle sensor which detects airborne moisture or particles and accordingly automatically operates the power windows or power roof without the intervention of the automobile operator. The system evaluates whether the moisture or particles are still contacting the automobile and may return the power roof or power windows to the position they were in prior to the moisture detection. The invention further includes an obstruction sensor for detecting whether an obstruction is impeding the operation of power roof and power windows, and an occupant sensor for determining whether there is an occupant in the automobile who may manually control the power windows and power roof, and operate the power roof and power windows accordingly.

### FIELD OF INVENTION

The present invention generally relates to automobiles having power windows and/or a power roof. More particularly, the invention relates to a system and method which detects airborne moisture or particles which are likely to damage the interior of an automobile, and for operating an automobile's power roof and power windows accordingly.

### BACKGROUND OF INVENTION

Convertible automobiles have become increasingly popular in sunnier regions of the world. A convertible automobile is one which includes a roof (i.e., “convertible roof” or “power roof”) which may be opened or lowered to permit access to the cockpit of an automobile from above. The power roof may be operated (lowered, opened, etc.) to permit passing wind to blanket the automobile driver during vehicle operation, or in the case of “sun roofs” or “moon roofs”, the roof is opened to permit the driver to enjoy the sky overhead. When the convertible roof is lowered or opened, the driver may feel an increased cooling sensation caused by air passing the vehicle without the need to operate the automobile cockpit cooling system (e.g., air-conditioning, ventilation system, etc.). Additionally, the automobile driver may lower the convertible roof to enjoy the warming or tanning affects of the sun, or the pleasant scenery provided by the night sky.

In some instances, an automobile driver may decide to leave the roof of his convertible automobile in the lowered or open position when the automobile is not occupied. For example, the driver may wish to make a “quick” purchase from a convenience store, or a gas station, where raising the convertible roof is typically inconvenient, since the automobile driver is absent from the vehicle for only a short period. Raising the roof only to lower it a short time later costs the driver needed time. The driver may find it more convenient to leave the roof in its lowered position since the driver will only leave his automobile unattended for a short period of time.

At other times, the driver may simply decide that raising the convertible roof is not necessary since the convertible automobile is parked in a safe location. For example, the driver may leave the roof of his convertible automobile in the lowered position when the automobile is parked at the driver's home in the driver's driveway. As such, the driver may not see a need to raise the convertible roof when the driver is away from the automobile even for an extended period of time.

Occasionally, the weather may unexpectedly change when the automobile's convertible top is in the lowered or opened position. The weather may suddenly or unexpectedly change from sunny to inclement. This is especially problematic when the automobile is unattended. When the driver leaves his automobile unattended and the roof in the lowered position, the interior of the automobile is exposed to the affects of the inclement weather. The inclement weather may produce moisture, such as rain, sleet, hail, snow, airborne dust, dirt, or the like, which may progress through the lowered convertible roof and come to rest on the automobile interior. The erosive affects of the moisture may ordinarily damage the interior of the automobile. The interior may become water-spotted, mildewed, waterlogged, or uncomfortable to the touch. Additionally, the material comprising the interior may become unattractive, worn, bunched, or the like.

A similar situation occurs in automobiles which do not have a convertible roof, but which have windows that may be lowered or raised as desired. Where the automobile driver leaves the automobile unattended and the windows in the lowered position, the interior of the automobile may be affected by the sudden change in the weather as described above.

Consequently, a need exists for a system and method which detects airborne moisture or particles in proximity to a vehicle and accordingly raises (e.g., closes) a lowered or opened convertible roof or window to protect the automobile's interior space.

### SUMMARY OF INVENTION

The present invention relates to a system and method for protecting the interior of an unattended automobile from damaging affects of moisture or airborne particles which may come to rest on the interior due to the automobile having a lowered convertible roof or windows. In one aspect, the invention includes a moisture sensor for detecting moisture in or around the automobile. The sensor may be positioned on an exterior portion of the automobile or in the automobile cockpit. The sensor may be in communication with an apparatus for controlling the open or closing of the automobile window or convertible roof. The sensor may detect the presence of moisture coming to rest on the interior or exterior of the automobile and send a signal to the controlling apparatus. The controlling apparatus may then send a signal to a positioning motor for raising or closing the window or roof.

In another aspect, the invention includes a moisture timing apparatus for determining the time during which moisture is no longer contacting the automobile. The moisture timing apparatus may be preset to a specific time period for which moisture is no longer contacting the automobile. Once the time has elapsed, then the moisture timing apparatus may send a signal to the controlling apparatus for lowering the windows or the convertible roof to its previous lowered position.

In yet another aspect, the invention includes an object detection sensor for determining the presence of an obstruction in the area or pathway in which the window or roof would travel or come to rest in the raised position. The object detection sensor may be in communication with the controlling apparatus. In one exemplary embodiment, the object detection sensor may detect an object by detecting the resistance to the raising window or roof. Where an object is detected by the sensor, the raising of the window or convertible top may be halted or reversed. For example, the object detection sensor may be a rotation sensor in communication with the controlling apparatus. The rotation sensor may detect when the window or roof meets an object impeding the raising of the window, by, for example, noting the rotational position of the motor for raising the window or roof relative to the position the motor would be in if the window or roof were fully closed. The motor may be a subpart of the controlling apparatus. If the motor has not completed rotation to a predetermined rotational position, then the rotation sensor may send a signal to the controlling apparatus that an obstruction is impeding the raising of the window or roof, or the window or roof is not in the substantially raised position. The rotation sensor may then send a signal to the controlling apparatus for halting operation of the roof or window, or for returning the roof or window to its prior position.

In another exemplary embodiment, the object detection sensor may be a power sensor. The power sensor may detect when the motor controlling the window or roof is expending a predetermined amount of power such as when the window or roof is abutting against an obstruction, or when the window or roof is in the substantially raised or closed position. In either case, the motor may exert a predetermined amount of power which is detected by the power sensor, and the power sensor may provide a signal to the controlling apparatus for halting operation of the window or roof, or to return the window or roof to its prior position.

In yet another aspect, the invention includes an automobile cockpit occupant sensor for determining if a person is seated in the cockpit of the automobile. The occupant sensor may be a pressure sensor situated in a portion of an cockpit occupant seat. The occupant sensor positioned in the seat may detect the presence of an occupant by comparing the downward pressure exerted on the seat with the downward pressure measured when the seat is unoccupied. Where an occupant is seated in the automobile cockpit, the occupant sensor may send a signal to the controlling apparatus to stop operation of the controlling apparatus thereby leaving the windows or roof in its then present position. Alternatively, the occupant sensor may be a motion sensor which detects movement within the cockpit. Where movement is detected, the occupant sensor may likewise send a signal to the controlling apparatus to stop operation of the controlling apparatus thereby leaving the windows or roof in its then present position.

In still another aspect, the invention includes an occupant timing apparatus for determining the time during which no movement is detected in the automobile. The occupant timing apparatus may work in conjunction with and be in communication with the occupant sensor apparatus to ensure that the object detected in the cockpit of the automobile is not inanimate. That is, where the occupant sensor determines when an occupant is present in the automobile cockpit, the occupant timing apparatus assists in determining whether the occupant is capable of manually operating the windows or the convertible roof. If an object detected by the occupant detection sensor does not raise the windows or doors in a preset period of time, the occupant timing apparatus may send a signal to the controlling apparatus for raising the windows or roof. The occupant timing apparatus may be preset to a specific time period for which the moisture is and for which the windows and roof have not been activated. If the windows and roof are not activated after a predetermined period of time, the occupant timing apparatus may provide a signal to the controlling apparatus to raise the convertible roof or windows.

In yet another exemplary embodiment, the invention may include a motion timer in communication with the motion sensor. The motion timer may be useful for determining the lapse of time between a first detection of motion by the motion sensor to a second detection of motion by the motion sensor. If the lapse in time equals a predetermined time period, then the motion sensor may send a signal to the controlling apparatus to raise the windows or roof to protect the vehicle interior. Alternatively, if the time period between the first detection and the second detection is less than the predetermined period, then the motion sensor may send a signal to the controlling apparatus for disabling controlling apparatus operation.

In yet another aspect, the invention includes a particle sensor for detecting the presence of solid material which may be airborne, and which is likely to come in contact with the automobile cockpit. The sensor may detect the solid material and send a signal to the controlling apparatus for raising the windows or the convertible roof to a raised position.

In still another embodiment, the invention may include a particle or moisture timer for determining the time period during which no moisture or particles are detected by the moisture sensor or particle sensor. The particle or moisture timer may be in communication with the controlling apparatus for sending a signal to lower the windows or roof to the lowered position. The particle or moisture timer may only be initiated once the particle sensor or moisture sensor detects the presence of moisture or particles which may damage the vehicle interior. Alternatively, the particle or moisture timer may be initiated after the controlling apparatus raises the windows or roof to the raised position. Further still, the particle or moisture timer may be initiated once the moisture sensor or particle sensor no longer detects the presence of moisture or particles which may damage the vehicle interior. If a predetermined period of time lapses as determined by the particle or moisture timer, then the particle or moisture timer may send a signal to the controlling apparatus for lowering the windows or roof to its prior lowered state. That is, the particle or moisture timer may be useful for determining that the moisture or airborne particles no longer are present.

In the manner described above, the present invention provides a system for protecting the interior of a vehicle from the affects of damaging moisture or particles, which is not found in the prior art. The system may be automatic in that it requires little or no outside intervention to initiate operation.

Additional features and advantages of the present invention are described in, and will be apparent from, the detailed description of the present exemplary embodiments and from the drawings.

### BRIEF DESCRIPTION OF DRAWINGS

A more complete understanding of the present invention may be derived by referring to the detailed description and claims when considered in connection with the Figures, where like reference numbers refer to similar elements throughout the Figures, and:

FIG. 1 illustrates an exemplary embodiment of an automobile having a convertible roof in the lowered position;

FIG. 2 illustrates an exemplary embodiment of an automobile having a convertible roof in the raised position;

FIG. 3 is an exemplary embodiment of a roof control system and a windows control system which may be used with the present invention;

FIG. 4 illustrates an exemplary embodiment of an automobile with the windows in the lowered position;

FIG. 5 illustrates an exemplary embodiment of an automobile with the windows in the raised position;

FIG. 6 illustrates an exemplary airborne moisture/particle detection system in accordance with an exemplary embodiment of the present invention;

FIG. 7 depicts an exemplary flowchart illustrating the general operation of an exemplary airborne moisture/particle detection system in accordance with an exemplary embodiment of the present invention;

FIG. 8 depicts an exemplary flowchart illustrating the operation of an exemplary airborne moisture/particle detection system including a motion sensor or timer in accordance with an exemplary embodiment of the present invention;

FIG. 9 depicts an exemplary flowchart illustrating the operation of an exemplary airborne moisture/particle detection system including a pressure sensor timer in accordance with an exemplary embodiment of the present invention;

FIG. 10 depicts an exemplary flowchart illustrating the general operation of an exemplary airborne moisture/particle detection system including a motion sensor, a pressure sensor and a timer in accordance with an exemplary embodiment of the present invention; and

FIG. 11 depicts an exemplary flowchart illustrating the operation of an exemplary airborne moisture/particle detection system including an obstruction detection system in accordance with an exemplary embodiment of the present invention.

### DETAILED DESCRIPTION

The present invention addresses the shortcomings of the prior art by providing a system and method for protecting the interior of an unattended vehicle from damaging elements which may come in contact with the interior when the vehicle is left with its windows or convertible roof in a open or lowered position. The invention provides for operation of an automobile power roof and power windows without intervention of the vehicle owner. The invention detects the presence of damaging elements such as moisture (e.g., humidity, rain, water, etc.) or particles (e.g., smoke, dust, dirt, etc.) which may come to rest on the vehicle's interior when the vehicle owner leaves the vehicle unattended and the roof or windows in a lowered or open position, and raises or closes the windows to a raised or substantially raised position to prevent the damaging particles or moisture from contacting the vehicle interior.

The present invention may be described herein in terms of functional block components, optional selections and various processing steps. Such functional blocks may be realized by any number of hardware and/or software components configured to perform to specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention, where included, may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like.

As noted, the invention provides a system and method for operation of a vehicle's automatic convertible roof and windows when a vehicle is unattended, to protect the vehicle cockpit from coming in contact with moisture or particles which may damage the interior. The system raises the windows or roof to a “raised position” or “closed position” when damaging elements such as moisture or particles are detected coming to rest in or on the vehicle. Additionally, the system may lower or open the windows or roof to a lowered position when the moisture or particles are no longer detected coming to rest on the vehicle.

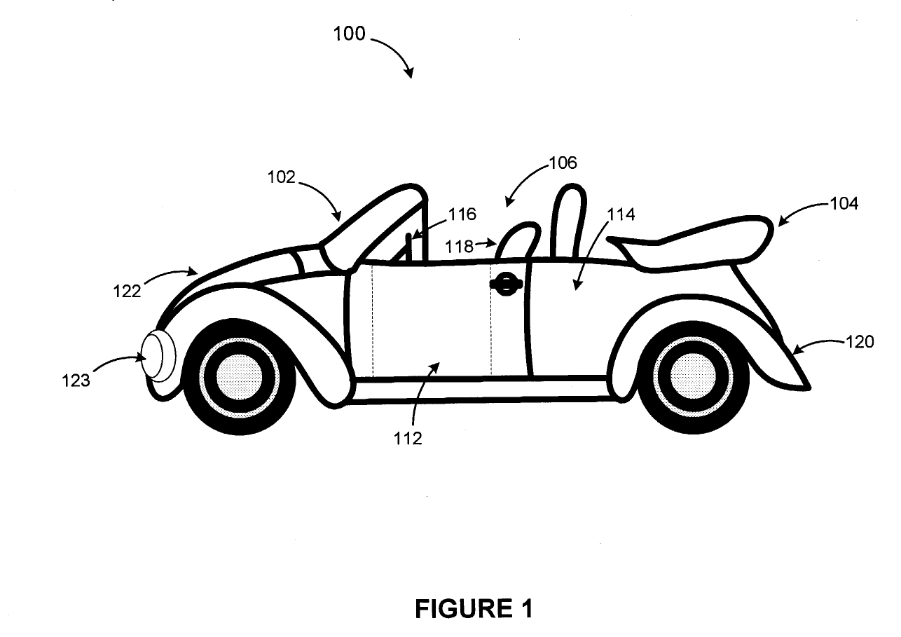

FIG. 1 illustrates an exemplary vehicle 100 including automatic convertible roof 104 (e.g., power roof), which may be found in the prior art. The vehicle 100 may include a windshield for shielding the vehicle operator from passing wind and debris when the vehicle 100 is operated, a cockpit 106, wherein a vehicle operator or vehicle occupants (not shown) may be seated during vehicle 100 operation. The cockpit 106 may be any conventional vehicle cockpit including a steering wheel 116 for controlling the directional movement of the vehicle 100, seats 118 upon which vehicle 100 occupants may be seated, and a vehicle dashboard (not shown) for providing status condition indicators (e.g., speed, revolutions per minute, oil pressure, engine temperature, or the like). Such cockpits are well known and as such, the cockpit 106 is not described herein in detail.

The vehicle 100 may be any vehicle found in the art which includes a convertible power roof, “sun roof” or “moon roof”. In this context, an “automatic” convertible roof (or “power roof”) is one that may be raised, opened, lowered or closed substantially without assistance from the vehicle owner. As shown in FIG. 1, roof 104 is depicted in a substantially lowered (e.g., open) position. When in the lowered position, the roof 104 may be collapsed on or in a rear portion 120 of the vehicle 100. Where the roof 104 collapses in the vehicle rear portion 120, the roof 104 may be stored in a storage compartment (not shown). As such, it should be noted that although the present invention is described with respect to a convertible roof, the invention is not so limited.

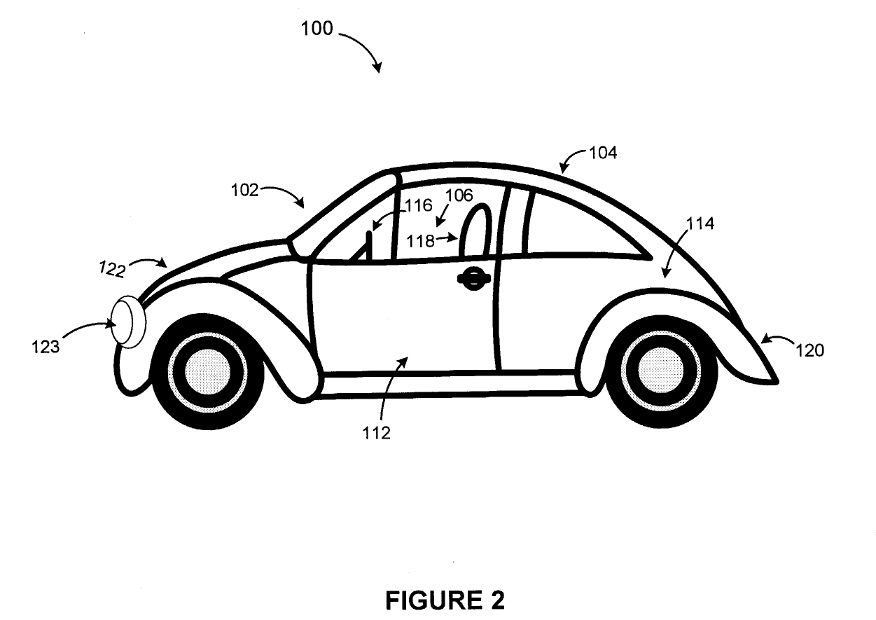

FIG. 2 depicts the vehicle 100 with convertible roof 104 in a substantially raised (e.g., closed) position. In accordance with the invention, the roof 104 may translate from a lowered position (shown in FIG. 1) to a raised position (shown in FIG. 2) by translation. Translation of the roof 104 from the lowered position to the raised position may take place along a generally horizontal path, an arcuate path, or by rotation and pivoting. The roof 104 may translate from the raised position to the lowered position in similar manner as when the roof 104 is raised. Moreover, the roof 104 can be constructed so that opening (e.g. lowering) and closing (e.g., raising) take place solely by substantially horizontal translation of the roof, such as in conventional sun roofs or moon roofs.

When the roof 104 is in the raised position, the cockpit 106 of the vehicle 100 is provided an overhead shield against any object attempting to gain access to the cockpit 106 from above. For example, the closed roof 104 may be positioned such that the cockpit 106 is substantially enclosed, making the cockpit 106 substantially protected from rain, sleet, hail, or other moisture which may otherwise come to rest on the vehicle 100 interior (e.g., seats 118, steering wheel 116, dashboard, etc.).

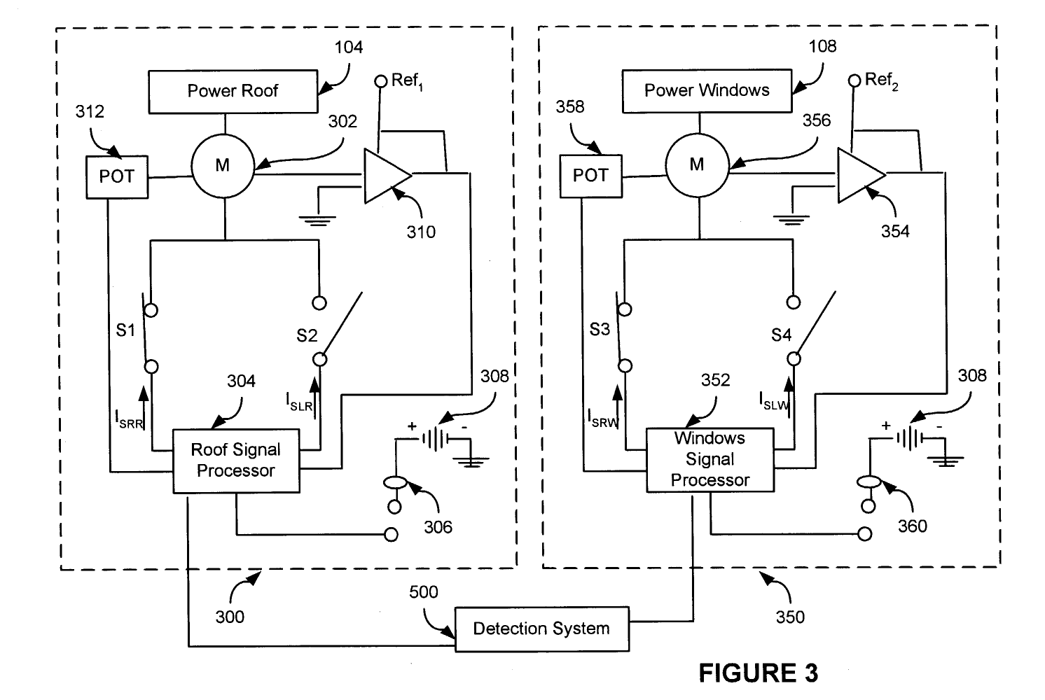

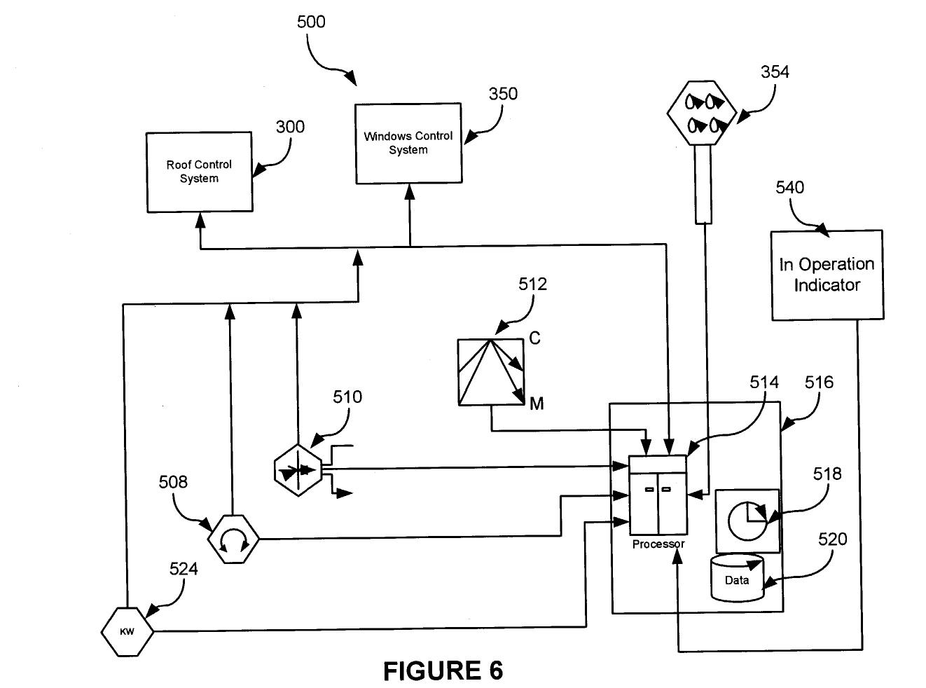

FIG. 3 depicts elementary elements of an exemplary roof control system 300 for controlling operation of the convertible roof 104, and an exemplary windows control system 350 for controlling the operation of power windows 108, which may be used with the present invention. Roof control system 300 and windows control system 350 may be connected to a detection system 500, described with respect to FIG. 6.

In accordance with the invention, the convertible roof 104 is designed for operation (i.e., to be raised, lowered, opened or closed) by means of an electric motor 302. The electric motor 302 may be in communication with a roof signal processor 304 via switches S1 and S2. The roof signal processor 304 may provide the motor 302 with operating signals for initiating the raising or lowering of roof 104. The roof signal processor 304 may be in communication with one or more activation buttons 306, which may provide the roof signal processor 304 with a signal for use by the processor 304 in determining whether the roof operator would like the roof 104 opened or closed. The motor 302 may be in communication with a comparator 310 for determining if the motor 302 is to continue to operate, for example, when the roof 104 is not in its desired raised or lowered position, or for determining that the operation of the motor 302 should be terminated, for example, when the roof 104 is in its desired position.

Motor 302 may be any motor capable of bidirectional rotation. That is, the motor may be able to operate in a forward and reverse direction so as to facilitate the raising or lowering of the power roof 104.

The motor 302 may be connected to a device 312 for detecting the rotational position of the motor 302. The device 312 may, for example, be a potentiometer 312 configured to detect the rotational movement of motor 302. Potentiometer 312 may be in communication with the window signal processor 304 for providing the window signal processor 304 with a signal indicating whether the motor has traversed the desired angular rotation sufficient for substantially raising or lowering the power roof 104 to its desired position.

Convertible roofs (sometimes called “power roofs” herein) may be controlled by a number of activation keys, (not shown) depending on the configuration of the roof. For example, roofs which open and close horizontally may be typically controlled by only two keys. One of these keys may function to open the roof while the other key may function to close the roof. The keys may operate a control element which can be linearly or angularly displaced between an inoperative position and two operative positions, namely, an operative position in which the roof is caused to open and an operative position in which the roof is caused to close.

Convertible roofs which can open and close both horizontally and rotationally are typically controlled by either four keys or two keys. If four keys are employed, two serve to respectively open and close the roof horizontally and two serve to respectively open and close the roof rotationally. On the other hand, when two keys are used, the function of each key depends upon the position of the roof, that is, whether the roof is closed, horizontally open or rotationally open. When the roof is closed, one of the keys functions to open the roof horizontally and one of the keys functions to open the roof rotationally. On the other hand, if the roof is open horizontally, either partially or fully, such as with a power “sun roof” or “moon roof,” the key used for horizontal opening retains this function while the other key now becomes operative to close the roof horizontally. The two keys keep these functions until the roof is closed. Finally, when the roof is partially or fully open rotationally, the key serving for rotational opening retains this function whereas the other key operates for rotational closing of the roof. Again, the keys retain such functions until the roof is closed. Thus, the function of one key is changed upon opening the roof and also upon closing the roof. Upon opening, the key other than that which was used to open the roof undergoes a change in function whereas, upon closing, the key which closed the roof undergoes a change in function.

The activating keys may be in communication with manual buttons 306, which may be depressed by the vehicle operator when the operator desires to raise or lower the roof 104. The button 306 may be any suitable button for sending operating signals to the aforementioned activation keys.

During operation of the convertible roof control system 300, a vehicle operator may depress button 306, which is connected to the positive terminal of the vehicle battery 308. When the button 306 is depressed, at least one configuration of the keys may send a signal to the window signal processor 304 for operating the power roof 104. For example, where the button 306 is the “raise roof button”, the processor 304 may send a raise roof signal to the motor 302. The raise roof signal may be in the form of a current I_{SRR} which may be sent to switch S1. Switch S1 may thereby close, causing the raise roof signal to be provided to the motor 302. The motor 302 may then rotate causing the roof 104 to translate from a substantially open position to a substantially closed position. By way of example, the motor may rotate clockwise to raise the roof 104 to a substantially closed position.

Alternatively, where the button 306 is the “lower roof button”, the processor 304 may send a lower roof signal to the motor 302. The lower roof signal may be in the form of a current I_{SLR} which may be sent to switch S2. Switch S2 may thereby close, causing the lower roof signal to be provided to the motor 302. The motor 302 may then rotate in an opposite direction (e.g., counterclockwise) thereby causing the roof 104 to translate from a substantially open or raised position to a substantially closed or lowered position.

Whether the roof 104 is to be lowered, opened, raised or closed, various resulting conditions of the motor 302 may be measured by a measuring apparatus for determining if the roof 104 is in the desired position. For example, the angular rotation of the motor 302 may be measured to determine if the desired position has been reached. Particularly, the system 300 may measure the angular distance traveled by the motor 302 and compare the distance traveled to the angular distance required for the motor 302 to reach the desired final position of the roof 104. For example, the system 300 may include a potentiometer 312 which reports the distance traveled by the roof 104 to the window signal processor 304. The potentiometer 312 may record the distance traveled and provide a reduced signal to the signal processor 304. The signal processor 304 may receive the signal and determine if the signal is representative of the angular position required for the roof 104 to be substantially raised or substantially lowered as desired. If the angular position of the motor 302 is in the desired position, then the processor 304 may send a signal to the corresponding switch S1 or S2 to open, thereby prohibiting any signal being provided to the motor 302, and the motor 302 ceases operation (e.g., rotation). Suitable automatic automotive convertible or power roof systems which may be used with the invention are disclosed in U.S. Pat. No. 6,288,511, issued Sep. 11, 2001, to Porter, et al., U.S. Pat. No. 5,209,544, issued May 11, 1993, to Benedetto, et al., U.S. Pat. No. 6,715,819, issued Apr. 6, 2004, to Weiss-mueller, U.S. Pat. No. 6,447,050, issued Sep. 10, 2002, to Plassmeyer, et al., U.S. Pat. No. 6,626,485 B2 issued Sep. 30, 2003, to Tamura, et al., and U.S. Pat. No. 6,644,729 B2 issued Nov. 11, 2003, to Sakai, et al., incorporated herein by reference.

Regarding the windows control system 350, the power windows 108 are also designed for operation (i.e., to be raised, lowered, opened or closed) by means of an electric motor 356. The electric motor 356 may be in communication with a window signal processor 352 via switches S3 and S4. The window signal processor 352 may provide the motor 356 with operating signals for initiating the raising or lowering of windows 108. The window signal processor 352 may be in communication with one or more activation buttons 360, which may provide the window signal processor 352 with a signal for use by the processor 352 in determining whether the windows operator would like the windows 108 opened or closed. The motor 356 may be in communication with a comparator 354 for determining if the motor 356 is to continue to operate, for example, when the windows 108 are not in the desired raised or lowered position, or for determining that the operation of the motor 356 should be terminated, for example, when the windows 108 are in the desired position.

Motor 356 may be of similar description as motor 302, namely motor 356 may be any motor capable of bidirectional rotation. That is, the motor may be able to operate in a forward and reverse direction so as to facilitate the raising or lowering of the power windows 108. The motor 356 may additionally be connected to a device 358 for detecting the rotational position of the motor 356. For example, the device 312 may be of similar description and operation as device 312. For example, device 358 may be a potentiometer 358 configured to detect the rotational movement of motor 356. Potentiometer 312 may be in communication with the window signal processor 352 for providing the window signal processor 352 with a signal indicating whether the motor 356 has traversed the desired angular rotation sufficient for substantially raising or lowering the power windows 108 to the desired position.

The windows control system 350 may also include activating keys (not shown) in communication with one or more manual buttons 360, which may be depressed by the vehicle operator when the operator desires to raise or lower the windows 108. The button 360 may be any suitable button for sending operating signals to the aforementioned activation keys.

During operation of the power windows control system 350, a vehicle operator may depress button 360, which may be connected to the positive terminal of the vehicle battery 308. When the button 360 is depressed, at least one configuration of the keys may send a signal to the window signal processor 352 for operating the power windows 108. For example, where the button 360 is the “raise window button”, the processor 352 may send a raise roof signal to the motor 356. The raise roof signal may be in the form of a current I_{SRW} which may be sent to switch S3. Switch S3 may thereby close, causing the raise window signal to be provided to the motor 356. The motor 356 may then rotate causing the windows 108 to translate from a substantially open position to a substantially closed position. By way of example, the motor may rotate clockwise to raise the windows 108 to a substantially closed position. Suitable systems for controlling an automatic automotive power window that may be used with the present invention are disclosed in U.S. Pat. No. 6,031,348, issued Feb. 29, 2000, to Fehr et al., U.S. Pat. No. 6,060,794, issued May 9, 2000, to Takagi, et al., U.S. Pat. No. 6,278,250, issued Aug. 21, 2001, to Sasaki, and U.S. Pat. No. 6,281,647, issued Aug. 28, 2001, to Sasaki, incorporated herein by reference.

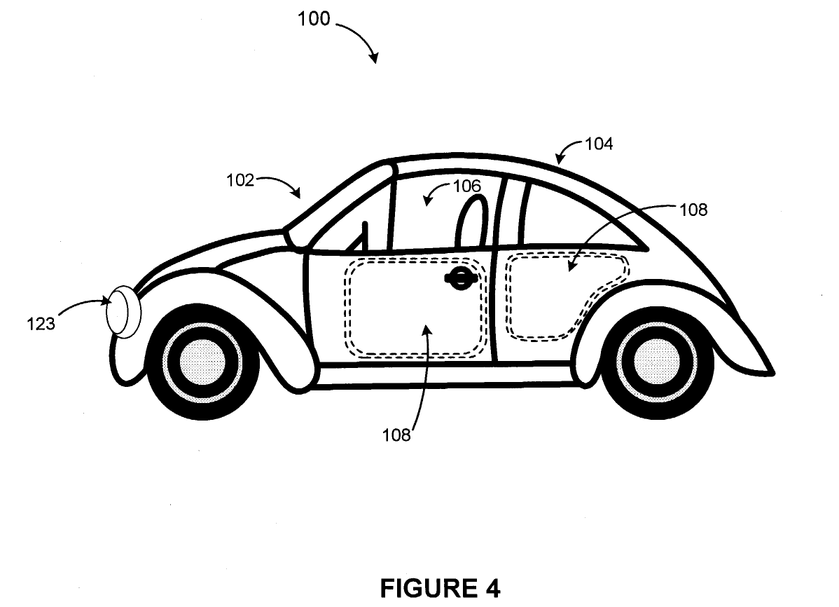

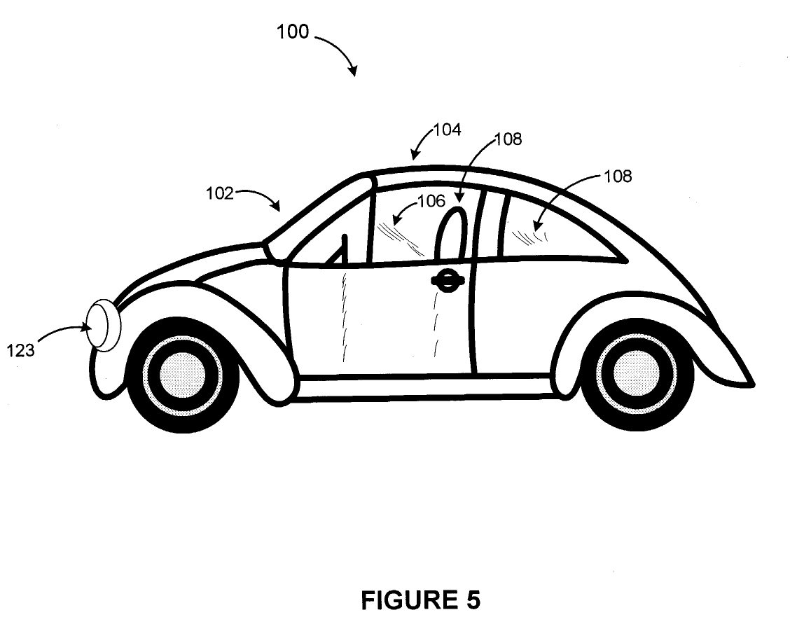

In this context, a “lowered” or “open” windows 108 may be partially or fully recessed within a vehicle door 112 and/or side panel 114, as shown in FIG. 4. Windows 108 may be considered “raised” or “closed” if the windows 108 are substantially raised from its recessed position in-side doors 112 or side panel 114. As shown in FIG. 5, windows 108 may be considered closed if the windows 108 would form a substantially closed enclosure when the roof 104 is raised or closed.

Alternatively, where the button 360 is the “lower windows button”, the processor 352 may send a lower windows signal to the motor 356. The lower window signal may be in the form of a current I_{SLW} which may be sent to switch S4. Switch S4 may thereby close, causing the lower window signal to be provided to the motor 356. The motor 356 may then rotate in an opposite direction (e.g., counterclockwise) thereby causing the windows 108 to translate from a substantially open or raised position to a substantially closed or lowered position.

In similar manner as is discussed with respect to roof 104, whether the windows 108 are to be lowered or raised, various resulting conditions of the motor 356 may be measured by a measuring apparatus for determining if the windows 108 are in the desired position. For example, the angular rotation of the motor 356 may be measured to determine if the desired position has been reached. Particularly, the system 350 may measure the angular distance traveled by the motor 356 and compare the distance traveled to the angular distance required for the motor 356 to reach the desired final position of the windows 108. For example, the system 350 may include a potentiometer 358 (or a servo-comparator or the like) which reports the distance traveled by the windows 108 to the window signal processor 352. The potentiometer 358 may record the distance traveled and provide a related signal to the signal processor 352. The signal processor 352 may receive the signal and determine if the signal is representative of the angular position required for the windows 108 to be substantially raised or substantially lowered as desired. If the angular position of the motor 356 is in the desired position, then the processor 352 may send a signal to the corresponding switch S3 or S4 to open, thereby prohibiting any signal being provided to the motor 356, and the motor 356 ceases operation (e.g., rotation).

It is known that all roofs and windows exhibit the drawback that they will remain open if the occupant forgets to close the roof or windows when leaving the vehicle. This in turn means that the interior of the vehicle is left vulnerable to moisture or airborne particles entering through the opening. This drawback cannot be eliminated for manually operated roofs or windows. On the other hand, such drawbacks may be overcome for convertible roofs or power windows. For example, a suitable system for overcoming the drawback may be used with power windows or roofs of the type where each closing or opening operation is controlled by a separate key. In one example, convertible roofs of the type where horizontal opening is controlled by a first key, horizontal closing by a second key and, if the roof opens rotationally, where rotational opening is controlled by a third key and rotational closing by a fourth key. Reference may be had, for example, to the Japanese publication JP-A-60 71 330, dated Apr. 23, 1985.

FIG. 6 illustrates components of an exemplary embodiment of an exemplary damaging element detection system 500 in accordance with the invention. The system 500 includes various sensors (508, 510, 512, 524, 534) configured to provide distinct signals to a processor 514. Operation of this exemplary embodiment of the invention may begin with the operation of damaging element detection sensor 534. Sensor 534 may be a humidity or moisture sensor for determining an accumulation of moisture. The sensor 534 may be positioned at any location on the surface of the automobile. Preferably the sensor is located to detect moisture contacting an upper surface of the automobile. For example, with reference to the automobile 100 shown in FIG. 1, the sensor 534 may be located on the automobile windshield 102. In this location, the sensor 534 may be positioned to detect moisture coming to rest on the windshield 102. Alternatively, the sensor 534 may be located in the automobile cockpit 106, at any location. The sensor 534 may be located on the automobile dashboard 112, seat 118, door 116, or any similar location on which moisture may come to rest. The sensor 534 may be mounted using any suitable attachment method as is known in the art. A suitable moisture sensor for use with the invention is disclosed in U.S. Pat. No. 6,433,501, issued Aug. 13, 2002, to Pientka, U.S. Pat. No. 6,573,995, issued Jun. 3, 2003, to Beutner, et al., U.S. Pat. No. 6,373,263, issued Apr. 16, 2002, to Netzer, and U.S. Pat. No. 6,369,378, issued Apr. 9, 2002, to Lamm, et al., incorporated herein by reference. Suitable attachment methods for attaching the sensor 534 to the automobile 100 are disclosed in U.S. Pat. No. 6,516,664, issued Feb. 11, 2003, to Lynam, and U.S. Pat. No. 6,581,484, issued Jun. 24, 2003, to Schuler, incorporated herein by reference.

It should be noted that damaging element sensor 534 may be a particle sensor for detecting amount of particles such as smoke particles, dirt particles, or dust particles in an environment in order to determine the criticality level of the particle density, and providing a signal to the processor 514 for similar processing as is described herein with the moisture sensor. The higher the particle density, the more likely it is that the particle will damage the interior of an unattended vehicle having its windows or roof in an open position. The particle sensor may be designed to include a photo-detector which provides an output voltage proportional to the amount of the particles carried on the air being monitored. A light emitter may be utilized in association with the photo-detector to project a light beam into a detection chamber for giving the scattered light due to the presence of the particles in the chamber. The scattered light may be collected by the photo-detector which, in turn, provides the output voltage indicative of the amount of the particles present in the chamber. A gain of the output voltage is then processed in order to satisfy a predetermined or regulation relationship between the output voltage and a particle density. Further, in order to cancel a background noise, i.e., a background voltage such as resulting from a stray light received by the photosensor, a suitable offset voltage reflecting the background voltage is combined with the output voltage to give a sensor output truly indicative of the amount or density of the particles. The gain control and the offset voltage are each realized by a mechanical variable resistor.

As such, although the damaging element detection sensor 534 is described with respect to a moisture sensor 534, it is contemplated that the invention may be adapted to include a particle sensor, which may be attached using any suitable conventional means at any location in the cockpit 106 to detect particulates which may damage the vehicle interior. Suitable particle sensors which may be used with the invention are disclosed in U.S. Pat. No. 6,611,611 B2 issued Aug. 26, 2003 to Oka, et al., U.S. Pat. No. 5,731,875 issued Mar. 24, 1998 to Chandler, et al., U.S. Pat. No. 6,479,825 B1 issued Nov. 12, 2002, to Weiss, and U.S. Pat. No. 6,091,494 issued Jul. 18, 2000 to Kreikebaum, incorporated herein by reference.

With reference to the exemplary embodiment depicted including a moisture sensor, if sensor 534 detects the presence of moisture, the embodiment 500 may initiate operations to raise or close the windows 108 or roof 104. The embodiment 500 may utilize various sensors to ensure safe operation of the windows 108 or roof 104. For example, the sensors may determine if an occupant is in the vehicle 102 or in the path traveled by the roof 104 or windows 108. Signals received from the sensors may be received by a detection system control device 516. System 516 may provide a signal to roof control system 300 or windows control system 350 for controlling operation of the roof 104 or windows 108, respectively.

System 516 may include a processor 514 for processing the signals. System 516 may include a database 520 which may store predetermined signal values to which processor 514 may compare signal values received from sensors 508, 510, 512, 524, 534 as described more fully below. The processor 514 may receive indicators or signals from moisture sensor 534, for example, for determining if the requisite amount of dirt or moisture has contacted the surface of the automobile 100 to initiate raising or lowering of the windows 108 or roof 104. The moisture signal received from moisture sensor 534 may be compared to predetermined moisture value stored in database 520. In that regard, the database 520 may store, for example, a predetermined moisture sensor detection value, a predetermined pressure sensor detection value, a predetermined rotational sensor pressure value, a predetermined power sensor detection value, or the like, which may be compared to correlative values received from sensors 508, 510, 512, 524, and 534. The database 520 may also store data indicative of various predetermined time periods which may be used to validate the signals received from the sensors 508, 510, 120, 524, and 534, or to check whether the conditions which initiate the operation of the system 500 are still occurring. The predetermined amounts may be determined by the automobile manufacturer or the owner. The predetermined amount may be populated into the database 520 using any conventional method for loading or storing data into a database.

The processor 514 may compare the values to determine whether to initiate or cease operation of the windows 108 or roof 104. The comparison may be done using any method for evaluating a first signal in view of a second signal. The method may depend on the quantity, quality, value or other characteristic of a portion of the signals compared. For information on automobile processor systems for use in controlling various automobile components, please refer to U.S. Pat. No. 4,348,726 issued Sep. 7, 1982, to Igarashi, et al., incorporated by reference.

In one exemplary embodiment, the invention may include sensors 510, 512 for detecting the presence of an occupant in the cockpit 106. In one instance, sensor 512 may be a pressure sensor located in the automobile seat 118 for detecting the downward pressure (e.g., force) exerted by an occupant seated in the seat 118. Sensor 510 sends a signal to processor 514 which is indicative of the amount of pressure being exerted on the seat 114. The pressure signal is received by the processor 514 which compares the pressure signal to a predetermined pressure signal value stored in database 520. If the signal received is greater than the predetermined pressure signal, the processor 514 may send a “cease operation” signal to the roof motor 302 in roof control system 300. Suitable pressure sensors for use with the invention are disclosed in U.S. Pat. No. 6,694,818, issued Feb. 24, 2004, to Chikuan, et al., U.S. Pat. No. 6,658,940, issued Dec. 9, 2003, to Burczyk, et al., and U.S. Pat. No. 6,640,640, issued Nov. 4, 2003, to Scholz, et al., incorporated herein by reference.

The system 500 may include a motion sensor 512 for detecting any motion generated by an occupant in the cockpit 106. The motion sensor 512 may be located on any surface permitting the sensor 512 to detect movement in the cockpit 106. For example, the motion sensor 512 may be located in the automobile dashboard 112, or near the automobile floor 118, door 116, or the cockpit side of the windshield 102.

The motion sensor 512 may detect motion with the cockpit 106 and translate the detected motion into a related motion detected signal. The motion sensor 512 may provide the motion detected signal to the processor 514. The processor 514 may receive the motion detected signal and send a cease operation signal to the roof control motor 302 or the windows control motor 356. If no motion is detected, the motion sensor 512 may provide no signal to the processor 514, or may send a “no motion detected” signal to the processor 514. A suitable motion sensor for use with the invention is disclosed in U.S. Pat. No. 6,583,725, issued Jun. 24, 2003, to Fehrenkamp, U.S. Pat. No. 6,434,451, issued Aug. 13, 2002, to Lohberg, et al., and U.S. Pat. No. 5,998,780, issued Dec. 7, 1999, to Kramer, incorporated herein by reference.

In some instances, the automobile operator may leave an obstruction in the path traveled by the raising roof 104. The obstruction may prevent the roof 104 or windows 108 from closing or being completely raised. As such, the invention may include sensors 508, 524 for determining if an obstruction is present which prevents the roof 104 or windows 108 from completely closing. The roof 104 or windows 108 may abut the obstruction and the rotation of motor 356 may be halted or slowed. Thus, the invention may include a rotation sensor 508 for detecting the slowing or halting rotation of the motor 356 which indicates the presence of the obstruction. For example, when an obstruction is abutted or the roof 104 or windows 108 are in the closed position, the sensor 508 may detect that the motor 356 has ceased rotation. The sensor 508 may then send a “rotation ceased” signal to the processor 514. The processor 514 may then send a signal to motor 302 or 354 to cease operation of those motors. A suitable rotation sensor for use with the invention is disclosed in U.S. Pat. No. 6,725,734, issued Apr. 27, 2004, to Toratani, et al., U.S. Pat. No. 6,491,019, issued Dec. 10, 2002, to Apel, and U.S. Pat. No. 6,329,815, issued Dec. 11, 2001, to Yamazaki, et al., incorporated herein by reference.

The invention may alternatively include a power sensor 524 for detecting the increased power which may be expended by the motor 306, 354 when the roof 104 or windows 108 abuts an obstruction or when the roof 104 or windows 108 is substantially closed, as described more fully below. When the power expended by the motor 302, 356 is increased, the sensor 524 may send a signal to the processor 514 for halting operation of the motor 302, 356. The signal provided by sensor 524 may be representative of the amount or value of the power expended by motor 306, 354. It is known that the motor 302, 356 ordinarily will increase the power expended when the roof 104 or windows 108 are substantially closed. A similar power expenditure would occur when the windows 108 or roof 104 abuts an obstruction. As such, when the obstruction is abutted, the sensor 524 may report the increase in power to the processor 514. The processor 514 may compare the reported power value with a predetermined power value stored in database 520. If the reported power value exceeds or meets a predetermined relationship with the predetermined value, the processor may send a “cease operation” signal to motor 302, 356. A suitable power sensor for use with the invention is disclosed in U.S. Pat. No. 6,587,211, issued Jul. 1, 2003, to Gelbart, U.S. Pat. No. 6,303,976, issued Oct. 16, 2001, to Gaitan, et al., and U.S. Pat. No. 5,973,486, issued Oct. 26, 1999, to Van Auken, incorporated herein by reference.

The controlling apparatus 516 may also include a timer 518 in communication with the processor 504. The timer 518 may be any conventional timer suitable for tracking, for example, the period of time from a first time t₁ to a second time t₂. The timer 518 may be useful for determining whether a condition initiating the operation of the detection system 500 still exists. For example, the timer 518 may measure whether moisture is still falling onto the vehicle 100, vehicle windshield 102, or vehicle cockpit. That is, the timer 518 may be useful for determining whether the moisture sensor 534 continues to detect moisture, by measuring the time period between a first detection of moisture and a second detection of moisture. For example, the timer 518 may be configured to measure a period beginning from about the first instance the moisture sensor 534 no longer detects moisture, t₁, to about the first instance the moisture sensor 534 detects moisture, t₂. If the time period between the first and second detection is sufficiently large, then the system 500 processor 514 may determine that moisture is no longer contacting the vehicle 100. If the processor 514 determines that the moisture is no longer contacting the vehicle, the processor 514 may send a signal to the roof control system 300 or the windows control system 350 to return the windows 108 or roof 104 to the position the windows 108 or roof 104 occupied prior to activation of the detection system 500.

In another exemplary embodiment, the timer 518 may be configured to assist in determining whether a the cockpit 106 of the vehicle 100 is occupied. The timer 518 may be useful in validating the motion signal received from motion sensor 512, or from pressure sensor 510. Where the motion sensor 512 detects motion in the cockpit 106, the controlling apparatus 516 processor 514 may receive a signal from motion sensor 512, which is indicative of an occupant being present in the cockpit 106. In some cases, however, the reading may be a false reading, especially if, for example, the motion sensor 512 is triggered by fast rushing wind or particles passing the sensor's effective detection range (e.g., the cockpit 106). The processor 514 and the timer 518 may be configured to validate that the signal is not a false reading by measuring the time period between a first detected movement and a second detected movement. If the measured time is of sufficient length, as compared to a predetermined motion period of time stored in database 520, the processor 514 may send a signal to roof control system 300 or the windows control system 350 for operation of windows 108 and roof 104. In this way, the system 500 determines whether an occupant is present who may be present for occupying the roof control system 300 or the windows control system 350, independently of the detection system 500. For example, the timer 518 may measure a period beginning from about the first instance in which motion sensor 512 no longer detects motion, t₁, and ending at from about the first instance the motion sensor 512 detects motion, t₂. Or, alternatively, timer 518 may measure a period beginning from about the first instance in which motion sensor 512 detects motion, t₁, and ending at from about the second instance the motion sensor 512 detects motion, t₂. If the time period between the first and second detection is sufficiently large, then the system 500 processor 514 may determine that motion is no longer detected in the vehicle 100. If the processor 514 determines that the motion is no longer detected in the vehicle 100 (e.g., period between detections is sufficiently long as compared to a predetermined motion detection time period), the processor 514 may send a signal to the roof control system 300 or the windows control system 350 to raise the roof 104 or windows 108. Alternatively, if the processor 514 determines that motion is present in the vehicle 100 (e.g., period between first and second detection of motion is shorter that the predetermined detection time period), the processor 514 may send a signal to the roof control system 300 or the windows control system 350 to cease operation. This in turn permits the vehicle occupant who triggers the motion sensor 512 to operate the roof control system and the windows control system 350 independently of detection system 500. If an occupant is detected by sensor 512, system 300, 350 may return the windows 108 or roof 104 to the position the windows 108 or roof 104 occupied prior to activation of the detection system 500.

The timer 518 may be used in similar manner as is discussed above with respect to the pressure sensor 510 to determine if the pressure reading is valid. That is, the timer 518 may be useful in determining if the pressure reading from the pressure sensor 510 is reporting a signal indicative of an occupant sitting on a vehicle seat 118. When an occupant is situated in a seat 118, the occupant will exert a certain amount of pressure on the seat sitting surface (not shown). The pressure is sensed by pressure sensor 510 and a signal indicative of the pressure sensed is sent to the processor 514 for comparison to a predetermined pressure signal value stored in database 520. If the pressure sensed is greater than the stored pressure signal value, then the processor 514 may determine that an occupant is in the seat 118. The processor may then send a signal to the roof control system 300 or the windows control system 350 for operation of the roof 104 or windows 108.

It is known that natural movement of a live occupant in a seat may ordinarily cause pressure fluctuations in the seat. As such, when there is a live occupant in the seat 118, the pressure sensor 510 may ordinarily experience pressure fluctuations due to the natural movement of the occupant. These pressure fluctuations may be sensed by the pressure sensor 510 and the pressure sensor may send a signal indicative of the pressure fluctuations to the processor 514. The frequency of the fluctuations, or the time period between fluctuations as measured by the timer 518 using any of the techniques described above, may be indicative of the presence of a live occupant in the seat 118. For example, if the time period between detected fluctuations (e.g. time period from t₁ to t₂) is sufficiently long as compared to a predetermined fluctuations time period stored in database 520, then the processor 514 may determine that no occupant is present in the cockpit 106, who can control operation of the windows 108 and roof 104. The processor may then send a signal to the roof control system 300 and the windows control system 350 for operating the roof 104 and windows 108. Alternatively, if the time period between detected fluctuations (e.g. time period from t₁ to t₂) is sufficiently short as compared to a predetermined fluctuations time period stored in database 520, then the processor 514 may determine that an occupant is present in the cockpit 106, and the processor 514 may send a signal to the roof control system 300 and the windows control system 350 to cease operation of the roof 104 and windows 108.

The timer 518 may also be configured to periodically initiate the sensors 508, 510, 512, 524, 534, to determine if the conditions relative to those sensors exist or continue to exist, and operate the roof control system 300 and the windows control system 350. For example, after the expiration of a predetermined period of time as measured by the timer 518 and compared to a predetermined period of lapse time stored in the database 520, the processor 514 may initiate a check of the sensors 508, 510, 512, 524, 534 to determine of the windows 108 or roof 104 should be raised or lowered, according to the signal received from the sensors 508, 510, 512, 524, 534 as described above.

In one exemplary embodiment, the amount of moisture or dirt accumulated on a surface of the automobile 100 may be considered in determining whether to raise or lower the automobile's windows 108 or roof 104. An indicator for the requisite amount of moisture or dirt for operating the roof 104 or windows 108 may be stored in a controller database 520.

In one exemplary embodiment the invention includes an in-operation indicator 540 for notifying the automobile 100 owner that the system 500 has been activated. In one example, the indicator 540 may be a visual indicator. For example, upon activation of system 500, the processor 514 may send signal to the operate a vehicle lighting system such as the cockpit interior lighting system (not shown) or the automobile parking lights, hazard lights, headlights or the like (referred to as “headlights 123” herein). That is, the processor 514 may turn the headlights 123 on so that the automobile operator may be visually made aware that the system 500 is operating to raise the windows 108 or roof 104. Headlights 123 may be any conventional automobile headlights as are conventionally known. Suitable automobile lighting systems and systems for operating headlights 123 for use with the invention may be disclosed in U.S. Pat. No. 5,331,520 issued Jul. 19, 1994, to Cejnek, U.S. Pat. No. 5,558,423 issued Sep. 24, 1996, to Schatka, et al., U.S. Pat. No. 6,719,444 B1 issued Apr. 13, 2004, to Alber, et al., and U.S. Pat. No. 6,561,688 B2 issued May 13, 2003, to Albou, U.S. Pat. No. 4,819,134 issued Apr. 4, 1989, to Rossi, U.S. Pat. No. 5,798,691 issued Aug. 25, 1998, to Tim Kao, U.S. Pat. No. 5,239,449 issued Aug. 24, 1993, to Wnuk, et al., U.S. Pat. No. 5,047,688 issued Sep. 10, 1991, to Alten, U.S. Pat. No. 5,184,883 issued Feb. 9,1993, to Finch, et al., U.S. Pat. No. 4,276,585 issued Jun. 30, 1981, to Deverrewaere, and U.S. Pat. No. 6,243,008 issued Jun. 5, 2001, to Korabiak, incorporated herein by reference.

In an alternate embodiment, the indicator 540 may be an audible indicator. In this instance, the indicator may be the automobile's horn or alarm system (not shown), or the like, which is activated upon activation of system 500. The alarm system can be heard by the operator. The processor 514 may send a signal to the alarm system to audibly notify the automobile operator that the system 500 has been activated. Suitable alarm and horn systems which may be used with the present invention are disclosed in U.S. Pat. No. 4,516,001 issued May 7, 1985, to West, U.S. Pat. No. 6,028,506 issued Feb. 22, 2000, to Xiao, and U.S. Pat. No. 5,793,122 issued Aug. 11, 1998, to Dingwall, et al., and the like, which are incorporated herein by reference.

In either instance, whether the indicator 540 is an audible indicator or a visual indicator, the processor 514 may send a signal to the indicator to cease indicator operation once the system 500 itself ceases operation.

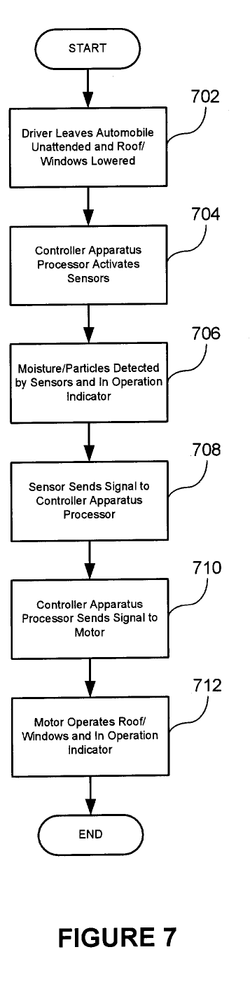

FIG. 7 is an exemplary flowchart illustrating the general operation of the present invention including the detection system 500. As shown, the system 500 may be initiated when the driver leaves the automobile 100 unattended and the roof or windows in the lowered or open position (step 702). The controller apparatus 516 may detect that the windows 108 or roof 104 is open and that the interior of the automobile 100 is left vulnerable to environmental changes, airborne moisture particles or the like. For example, it is known to report the position of the window or roof to an automobile central processing unit. Such a report may also be made to the controlling apparatus processor 514 using similar conventional methods.

The controller apparatus 516 may receive the report that the windows 108 or roof 104 are open and accordingly activate the sensors 508, 510, 512, 524, and 534 (step 704). Sensor 534 may detect the presence of airborne moisture or particles (step 706). Upon detection of the moisture or particles, the controller apparatus 516 may send a signal to the in-operation indicator 540 for notifying the vehicle operator that the system 500 has been activated (Step 706). The indicator 540 may notify the vehicle operator of system 500 operation at various stages of the operation. For example, the indicator 540 may notify the operator upon commencement of system 500 operation, upon initiating closing of the windows 108 or power roof 104, when system 500 detects an obstruction preventing system 500 operation, or when the system 500 ceases operation. The indicator 540 may be configured to provide different distinct notifications depending on the different stages or steps of the system 500 operation. In a typical example, the indicator 540 may provide a first notification where the system 500 is initiated, and a second notification different from the first notification when the system 500 operation is impeded by an obstruction, and a third notification different from the first and second notifications when the system 500 ceases operation.

Where the indicator 540 is a visual indicator, such as headlights 123 (or automobile lighting system.), the controller apparatus 516 may send a signal to the headlights 123 to light up. The lights may stay on for the duration of the operation of system 500. Additionally, the lights may flash intermittently or may oscillate between “high beams” and “low beams.” The controller apparatus 516 may send a signal to the headlights 123 to flash at different predetermined intervals or candescent levels according to the separate stages or steps in the operation of system 500.

Alternatively, where the indicator 540 is a horn, such as the automobile horn, the controller apparatus 516 may send a signal to the horn to emit an audible sound. The audible sound may be admitted for the duration of the operation of system 500. The horn may emit the audible sound intermittently, for example, emitting short horn burst, or the horn may remain on for the duration of the operation of system 500. Further, the controller apparatus 516 may send a signal to the horn to emit an audible notice at different predetermined intervals or different audible levels or durations to form a distinct audible sound pattern according to the separate stages or steps in the operation of system 500.

Similarly, if the indicator 540 is an alarm system, such as an automobile antitheft system, the controller apparatus 516 may send a signal to the alarm system to emit an audible sound. The audible sound may be admitted for the duration of the operation of system 500. The alarm system may emit the audible sound intermittently (e.g., short audible burst), or the alarm system may remain on for the duration of the operation of system 500. Further, the controller apparatus 516 may send a signal to the alarm system to flash at different predetermined intervals or different audible levels (e.g., different audible tones) or durations according to the separate stages or steps in the operation of system 500.

Upon detection of moisture or particles by the moisture sensor 534 (step 706), the moisture sensor 534 may send a signal indicative of the detected moisture (or particles) to the controlling apparatus 516 for processing (step 708). The controller apparatus 516 may send a control signal (e.g., a raising, closing, opening or lowering signal) to the roof control system 300 or the windows control system 350 for operation of the roof 104 or windows 108, respectively (step 710). The roof signal processor 304, or the windows signal processor 352, may receive the control signal and send a signal to the motor 302, 356 for controlling the operation of the roof 104 or windows 108. The motor 302, 356 may then operate the roof 104 or windows 108 in accordance with the signal from the processor 304, 352 (step 712). For example, if the control signal is a “raise” or “close” element signal, the motor 302, 356 may operate to raise or close the roof 104 or windows 108 accordingly. Contrariwise, if the control signal is a “lower” or “open” element signal, the motor 302, 356 may operate to lower or open the roof 104, or windows 108. Once the system 500 has completed operation, the controller apparatus 516, via processor 514, may send a signal to the in-operation indicator 540 to notify the vehicle operator that the system 500 has completed operation. The controller apparatus 516 may additionally send a signal to the indicator 540 to cease notification (step 712).

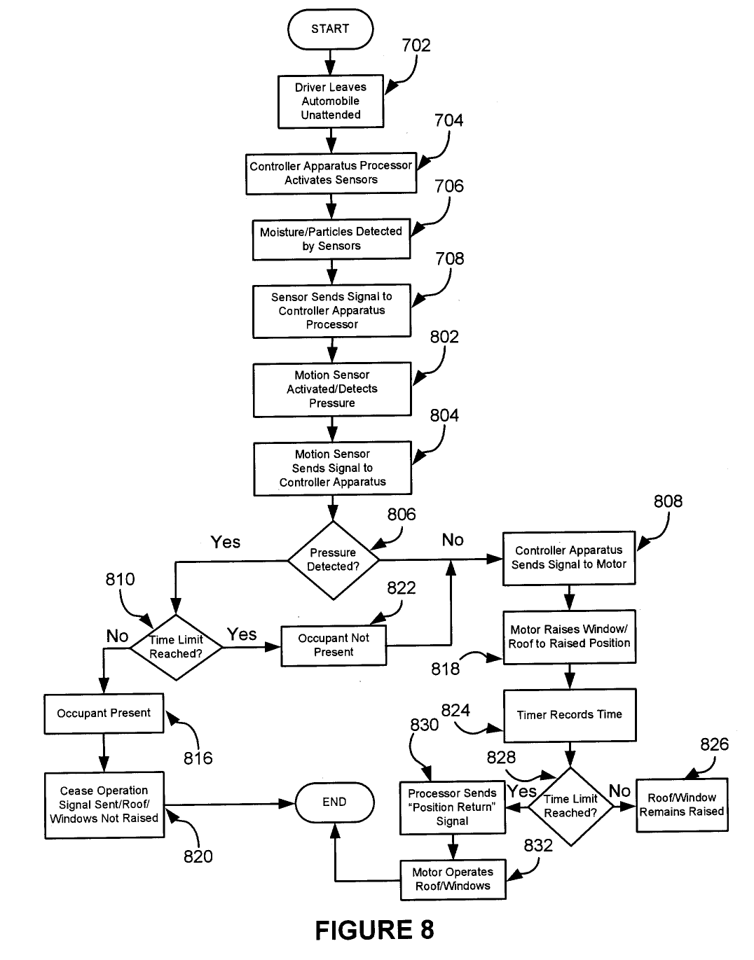

As noted, the invention has several safeguards for ensuring safe operation of the system 500. For example, FIG. 8 depicts an exemplary flowchart illustrating an exemplary method for detecting if an occupant is in the vehicle who may control the window control system 350 and the roof control system 300, independent of system 500.

The method shown in FIG. 8 may begin in similar manner as is described with respect to the general method shown in FIG. 7. The automobile driver may leave the vehicle 100 unattended with the windows 108 or the roof 104 in the lowered position (e.g., “open”) (step 702); the controller apparatus 516 may detect that the windows 108 or roof 104 is open and accordingly activate the sensors 508, 510, 512, 524, and 534 (step 704); sensor 534 may detect the presence of airborne moisture or particles (step 706); the moisture sensor 534 may then send a signal indicative of the detected moisture to the controlling apparatus 516 processor 514 for processing (step 708).

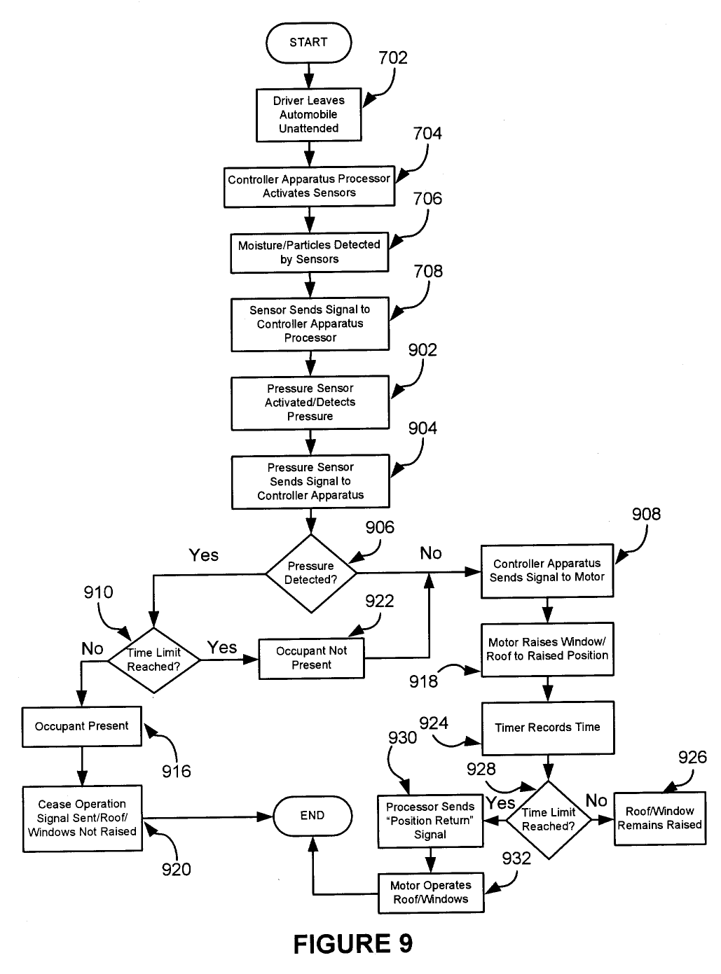

In one exemplary embodiment, the detection system 500 may include a motion sensor 534 for detecting motion within the vehicle cockpit 106. Detecting the motion may be useful for determining if an occupant is present in the vehicle 100. As such, when one of the moisture sensors sends a signal to the processor 514 indicating the presence of airborne moisture, the processor 514 may seek to determining whether the cockpit 106 is occupied. As shown in FIGS. 8-9, system 500 may use a motion sensor 512, a timer 518, a pressure sensor 510 disposed in at least one vehicle seat 118, or any combination thereof.

For example, in FIG. 8 what is shown is that processor 514 may activate the motion sensor 512 (step 802). Motion sensor 512 may provide the processor 514 a signal indicative of motion being detected (e.g., “motion detected” signal) in the cockpit 106 (step 804). If no motion is detected (step 806), the processor 514 sends a “raise element” signal to the motor 302, 356 (step 808) via processor 304, 352. The motor 302, 356 may then raise the windows 108 and/or roof 104 to the raised or closed position (step 818).

Alternatively, if motion is detected (step 806), the processor 514 may seek to validate the motion signal to ensure that no false reading is reported by the motion sensor 512. The processor 514 may compare a first motion detected signal with any subsequent motion detected signal which may be reported by the motion sensor 512. For example, if no motion is detected after a predetermined period of time, then the processor 514 may determine that the initial motion detected signal was a false positive reading. The processor 514 may seek to validate the motion detected signal when a timer 518 is present. If the timer is present, the processor 514 may compare the time which may elapse between a first and second motion detected signal (e.g., It |t₂−t₁|, where t₁ is the time at which the first motion detected signal is received and t₂ is the time at which the second motion detected signal is received), against a predetermined motion time limit stored in database 520 (step 810). If the measured time limit between the first and second motion detected signals is less than the predetermined motion time limit stored in database 520, then the time limit is not considered reached and the processor 514 may determine that an occupant is present in the cockpit 106, who can operate the roof control system 300 or the window control system 350 (step 816). Accordingly, the processor 514 may send a “cease operation” signal to the roof control system 300 or the window control system 350 to interrupt, cease or not initiate operation of the motor 302, 356, and the window 108 or roof 104 is not raised or closed (step 820). Alternatively, if the measured time limit between the first and second motion detected signals is greater than the predetermined motion time limit stored in database 520 (step 810), then the time limit is considered reached and the processor 514 may determine that no occupant is present in the cockpit 106 (step 822). Accordingly, the processor 514 may send a “raise element” control signal to the motor 302, 356 of roof control system 300 or the window control system 350 to raise the windows 108 or roof 104 (step 808). The motor then operates to raise the window accordingly (step 818).

In another exemplary embodiment, the detection system 500 may seek to determine if timer 512 may be used to determine if motion is still present after a predetermined period of time by recording the first and subsequent instances of motion detection and recording the duration between detections. If motion is detected before the expiration of the predetermined “no motion detected” time period (step 828), the time period is not considered reached, and the processor does not send a signal to the motor 302, 356 for operating the roof 104 or windows 108. That is, the roof 104 or windows 108 remain in the raised position (step 826). Alternatively, if no motion is detected after the predetermined period of time (step 828), the time “no motion detected” time period is considered reached and the processor 514 may send a signal the roof control system 300 or the windows control system for returning the roof 104 or windows 108 to the position the roof 104 or windows 108 (step 830) such that when the vehicle operator left the vehicle unattended, or for lowering or opening the roof 104 or windows 108 substantially (step 832).

FIG. 9 shows an exemplary method of operation of system 500 illustrating a similar usage of the timer 512 for determining if an occupant is present. In this exemplary embodiment, system 500 includes a pressure sensor 510 which may be used in conjunction with a timer 518 and a motion sensor 512, although it should be understood that the system 500 may be operated in similar manner as shown in FIG. 8 wherein similar steps as described with respect to motion sensor 512 may be used with pressure sensor 510 to validate, for example, the pressure sensor signal (“occupant present” signal) received from sensor 510.

The method of FIG. 9 begins in similar manner as the methods of FIGS. 7 and 8. Namely, the method of FIG. 9 may begin with the automobile driver leaving the vehicle 100 unattended with the windows 108 or the roof 104 in the lowered position (e.g., “open”) (step 702); the controller apparatus 516 may detect that the windows 108 or roof 104 is open and accordingly activate the sensors 508, 510, 512, 524, and 534 (step 704); sensor 534 may detect the presence of airborne moisture or particles (step 706); the moisture sensor 534 may then send a signal indicative of the detected moisture to the controlling apparatus 516 processor 514 for processing (step 708).

The processor 514 may activate the pressure sensor 510 (step 902). Pressure sensor 510 may provide the processor 514 a signal indicative of downward pressure being exerted on seat 118 (e.g. “pressure detected” signal) in the cockpit 106 (step 904). If no pressure is detected (step 906), the processor 514 sends a “raise element” signal to the motor 302, 356 (step 908) via processor 304, 352. The motor 302, 356 may then raise the windows 108 and/or roof 104 to the raised or closed position (step 918).

Alternatively, if pressure is detected (step 906), the processor 514 may seek to validate the motion signal to ensure that no false reading is reported by the pressure sensor 510. The processor 514 may compare a first pressure detected signal with any subsequent pressure detected signal which may be reported by the pressure sensor 510. For example, if no pressure is detected after a predetermined period of time, then the processor 514 may determine that the initial pressure detected signal was a false positive reading. The processor 514 may seek to validate the motion detected signal when a timer 518 is present. If the timer is present, the processor 514 may compare the time which may elapse between a first and second pressure detected signal (e.g., |t₂−t₁|, where t₁ is the time at which the first pressure detected signal is received and t₂ is the time at which the second pressure detected signal is received), against a predetermined pressure detected time limit stored in database 520 (step 910). If the measured time limit between the first and second pressure detected signals is less than the pressure detected time limit stored in database 520, then the processor 514 may determine that an occupant is present in the cockpit 106, who can operate the roof control system 300 or the window control system 350 (step 916). Accordingly, the processor 514 may send a “cease operation” signal to the roof control system 300 or the window control system 350 to interrupt, cease or not initiate operation of the motor 302, 356, and the window 108 or roof 104 is not raised or closed (step 920). Alternatively, if the measured time limit between the first and second pressure detected signals is greater than the predetermined pressure detected time limit stored in database 520 (step 914), then the processor 514 may determine that no occupant is present in the cockpit 106 (step 922). Accordingly, the processor 514 may send a “raise element” control signal to the motor 302, 356 of roof control system 300 or the window control system 350 to raise the windows 108 or roof 104 (step 908). The motor 302, 356 then operates to raise the roof 104 or windows 108 accordingly (step 918).

In another exemplary embodiment, the detection system 500 may seek to determine if timer 512 may be used to determine if pressure is still being detected after a predetermine period of time. If pressure is detected before the expiration of the predetermined “no pressure detected” time period (step 928), the time period is not considered reached, and the processor 514 sends a signal to the motor 302, 356 for operating the roof 104 or windows 108. That is, the roof 104 or windows 108 remain in the raised position (step 926). Alternatively, if no pressure is detected after the predetermined period of time (step 928), the time “no pressure detected” time period is considered reached and the processor 514 may send a signal the roof control system 300 or the windows control system for returning the roof 104 or windows 108 to the position the roof 104 or windows 108 (step 930) such that when the vehicle operator left the vehicle unattended, or for lowering or opening the roof 104 or windows 108 substantially (step 932).

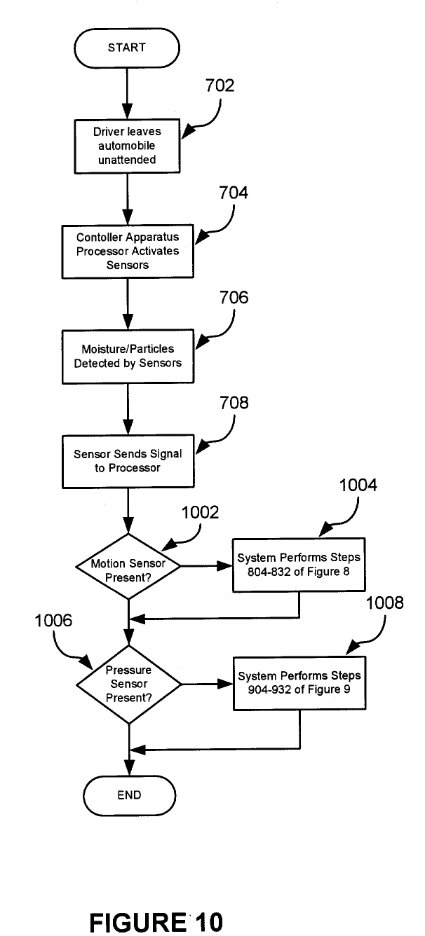

It should be understood that the system 500 may use any combination of timer 518, motion sensor 512, and pressure sensor 510 to determine the presence of a vehicle occupant. For example, FIG. 10 shows an exemplary method employing the timer 518, motion sensor 512, and pressure sensor 510, which may be used with the present invention. The method of FIG. 10 begins in similar manner as FIGS. 7, 8, and 9. The automobile driver may leave the vehicle 100 unattended with the windows 108 or the roof 104 in the lowered position (e.g., “open”) (step 702); the controller apparatus 516 may detect that the windows 108 or roof 104 is open and accordingly activate the sensors 508, 510, 512, 524, and 534 (step 704); sensor 534 may detect the presence of airborne moisture or particles (step 706); the moisture sensor 534 may then send a signal indicative of the detected moisture to the controlling apparatus 516 processor 514 for processing (step 708).

If the motion sensor is present (step 1002), the processor 514 may activate the motion sensor 512 and the detection system 500 perform steps 804-832 of FIG. 8 (step 1004). If no motion sensor 512 is present (step 1002), the processor 514 may determine if a pressure sensor 510 is present (step 1006). If a motion sensor 512 is present in system 500, then the system 500 may perform steps 904-932 of FIG. 9 (step 1008).

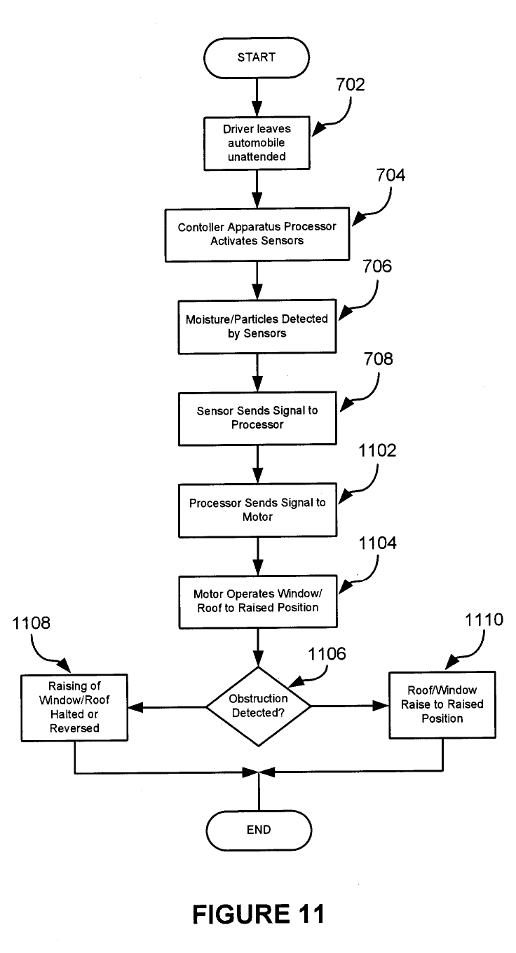

Detection system 500 may also be configured for safe operation in that the system 500 may be configured to determine whether there is an obstruction in the path which would be followed by a roof 104 or windows 108 being raised. In this exemplary method, system 500 may include an obstruction detection system including one or more rotation sensors 508 or power sensors 524, shown in FIG. 5 and discussed above. FIG. 11 illustrates an exemplary method of operating detection system 500 to detect obstructions in accordance with the invention. The exemplary method may begin with the automobile driver leaving the vehicle 100 unattended with the windows 108 or the roof 104 in the lowered position (e.g., “open”) (step 702); the controller apparatus 516 may detect that the windows 108 or roof 104 is open and accordingly activate the sensors 508, 510, 512, 524, and 534 (step 704); sensor 534 may detect the presence of airborne moisture or particles (step 706); the moisture sensor 534 may then send a signal indicative of the detected moisture to the controlling apparatus 516 processor 514 for processing (step 708); the processor 514 may send a control signal to the motor 302, 356 for raising or opening the roof 104 or windows 108 (1102); and the motor 302, 356 may initiate the raising of roof 104 or windows 108 (step 1104).

The system 500 may then determine if an obstruction is present using the rotation sensor 508 and/or the power sensor 524 as described above (step 1106). That is, as the roof 104 or windows 108 are being raised, the rotational position (angular rotation) of the motor 302, 304 may be measure by the sensor 508. The sensor 508 may provide a signal to the processor 514 which is indicative of the angular position or angular rotation of the motor 302, 356. The processor 514 may compare the angular position or rotation of the motor 302, 356 with a predetermined “rotation completed” value stored in database 520 where the rotation completed value represents the angular position or angular rotation of the motor 302, 356 when the roof 104 or window 108 is substantially raised. Where the roof 104 or windows 108 abut an obstruction during the raising operation, the rotational movement of the motor 302, 356 may be halted, thereby causing the rotation sensor 508 to report a signal to the processor 514 that is less than the angular rotation or angular position of the motor 302, 356 had the obstruction not been present. The processor 514 may compare the angular rotation or position reported by the sensor 508 to the predetermined “rotation completed” value, and if the reported value is less, the processor 514 may send a control signal to the motor 302, 356 for ceasing motor 302, 356 operation, or for reversing the direction of the motor 302, 356 to lower the roof 104 or window 108 (step 1108).

Similarly, the detection system 500 may include a power sensor 524 for detecting the power expended by the motor 302, 356 when raising the roof 104 or windows 108. If the raising roof 104 or windows 108 abut an obstruction, the motor 302, 356 may ordinarily expend more power to attempt to pass through the obstruction, than the motor 302, 356 may ordinarily expend when raising the roof 104 or windows 108 when no obstruction is present. The expenditure of power may be sensed by the power sensor 524 as an unexpected increase in power expenditure, power surge or a power spike. Once the spike is detected, the sensor 524 may provide a signal indicative of the unexpected power expenditure to the processor 514. The processor 514 may compare the power expenditure to a predetermined power level stored in database 520, where the predetermined power level is representative of the amount of power motor 302, 356 ordinarily expends in raising the roof 104 or windows 108. If the power expenditure reported by sensor 524 is greater than the predetermined power level, the processor 514 may send a control signal to the motor 302, 356 for ceasing motor 302, 356 operation, or for reversing the direction of the motor 302, 356 to lower the roof 104 or window 108 (step 1108). In either instance if no obstruction is present, the roof 104 or windows 108 may be raised to the desired raised position (step 1110).

It should be noted that rotation sensor 508 may work in conjunction with power sensor 524 to detect the presence of an obstruction in the path of the raising roof 104 or window 108. For example, once sensor 524 reports a power surge to the processor 514 by, the processor 514 may seek to validate that the roof 104 or window 108 is substantially raised. The processor 514 may receive the signal from sensor 524 and compare the signal received from rotational sensor 508 with a predetermined “rotation completed” value stored in database 520 as is discussed above. Alternatively, if the rotation sensor 508 reports to the processor 514 an angular rotation or position signal indicating that the raising roof 104 or window 108 is halted, the processor 514 may seek to validate that the roof 104 or window 108 is substantially raised. The processor 514 may receive a signal from sensor 524 and compare the signal received from power sensor 524 with a predetermined power level value stored in database 520 as is discussed above. In either case, if an obstruction is detected, the processor 514 may send a control signal to the motor 302, 356 for ceasing motor 302, 356 operation, or for reversing the direction of the motor 302, 356 to lower the roof 104 or window 108.

The system 500 may additionally employ a timer 512 for validating the obstruction detected signals (e.g., “rotation halted signal” or unexpected “power surge signal”) received from sensors 508, 524. The timer 512 may be used to determine whether the signals received are detected over a predetermined period of time (e.g., “an obstruction detected” period). The processor 514 may receive a first signal measured at time t₁ and a second signal measured and time t₂, and determine the total duration of the time the obstruction detected signal is provided to the processor 514. The total time the obstruction detected signal is received is then compared to an obstruction detected validating period stored in database 520. If the obstruction detected signal time period is greater than the obstruction detected validating period, an obstruction may be present, and the processor may send a control signal to the motor 302, 356 to cease or reverse operation of the motor 302, 356.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the preceding detailed description is presented for purposes of illustration only and not of limitation, and the scope of the invention is defined solely by the appended claims and their legal equivalents when properly read in light of the preceding description. For example, the steps recited in any of the method or process claims may be executed in any order and are not limited to the order presented.

1. A system for automatically operating automatic power systems of an unattended automobile comprising:
a damaging element detection sensor for detecting damaging elements contacting a surface of said automobile;
an automatic power system control unit for operating said automatic power system; and
a processor in communication with said damaging element detection sensor and said automatic power system.

2. A system according to claim 1, wherein said automatic power system is one of an automatic power roof system and an automatic power windows system.

3. A system according to claim 1, wherein said damaging element detection sensor is configured to provide a first damaging element detection reference signal to said processor, said first damaging element detection signal representative of a first damaging element detection level detected by said damaging element detection sensor.

4. A system according to claim 3, wherein said processor is configured to receive said first damaging element detection reference signal and generate a first control signal, said processor configured to provide said first control signal to said automatic power system control unit.

5. A system according to claim 4, wherein said automatic power system control unit further comprises a motor for controlling the positioning of at least one of said automatic power roof system and automatic power windows system, said automatic power system control unit further configured to provide a first motor control signal to said motor in response to said first control signal.

6. A system according to claim 5, wherein said motor is bidirectional.

7. A system according to claim 5, wherein said motor is responsive to adjust the position of at least one of said automatic power roof system and automatic power windows system in response to said first control signal.

8. A system according to claim 5, wherein said damaging element detection sensor is further configured to provide a second damaging element detection reference signal to said processor.

9. A system according to claim 8 further comprising a database in communication with said processor, said database configured to store at least one predetermined reference signal and provide said at least one predetermined reference signal to said processor.

10. A system according to claim 9, further comprising a timer in communication with said processor, said timer configured to receive said first and second damaging element detection reference signals and provide a damaging element detection duration signal indicative of the time duration difference between said first and second damaging element detection reference signals.

11. A system according to claim 10, wherein said processor is further configured to receive said damaging element detection duration signal and compare said damaging element detection duration signal to said at least one predetermined reference signal, said at least one predetermined reference signal being a damaging element detection duration data stored in said database, said damaging element detection duration data representative of the duration during which no damaging element detection is detected by said damaging element detection sensor.

12. A system according to claim 11, wherein said processor is configured to provide a second control signal in response to said comparison of said damaging element detection duration signal and said predetermined damaging element detection duration data.

13. A system according to claim 12, wherein said processor is configured to provide said second control signal to said automatic power system control unit, said automatic power system control unit further configured to provide a second motor control signal to said motor in response to said second control signal, said motor configured to control the positioning of said at least one of said automatic power roof system and automatic power windows system in response to said second motor control signal.

14. A system according to claim 5, further comprising an occupant sensor, said occupant sensor configured to provide a first occupant present signal to said processor, said first occupant present signal indicative of an occupant being in a cockpit of said automobile.

15. A system according to claim 14, wherein said occupant sensor is one of a motion sensor and a pressure sensor.

16. A system according to claim 14, wherein said processor is configured to provide a first occupant present control signal to said automatic power system control unit in response to said first occupant present signal, said automatic power system control unit further configured to provide a motor cease operation signal to said motor in response to said first occupant present control signal, said motor configured to control the positioning of said at least one of said automatic power roof system and automatic power windows system in response to said first occupant present signal.

17. A system according to claim 16, wherein said occupant sensor is configured to provide a second occupant present signal to said processor, said second occupant present signal indicative of an occupant being in the cockpit of said automobile.

18. A system according to claim 17, further comprising a timer in communication with said processor, said timer configured to receive said first and second occupant present signals from said processor, said timer configured to provide an occupant present reference signal to said processor.

19. A system according to claim 18, wherein said processor is further configured to receive said occupant present reference signal and compare said occupant present reference signal to said at least one predetermined reference signal, said at least one predetermined reference signal being a predetermined occupant present reference data stored in said database, said predetermined occupant present reference data representative of the duration during which no occupant is detected in said cockpit by said occupant detection sensor.

20. A system according to claim 19, wherein said processor is configured to provide an occupant present control signal in response to said comparison of said occupant present reference signal to said at least one predetermined reference signal.

21. A system according to claim 20, wherein said processor is configured to provide said occupant present control signal to said automatic power system control unit, said automatic power system control unit further configured to provide an occupant motor control signal to said motor in response to said second occupant present control signal, said motor configured to control the positioning of said at least one of said automatic power roof system and automatic power windows system in response to said second occupant present control signal.

22. A system according to claim 5, further comprising an obstruction sensor, said obstruction sensor configured to provide a first obstruction present signal to said processor, said first obstruction present signal indicative of an obstruction impeding the operation of said automatic power system.

23. A system according to claim 22, wherein said obstruction sensor is one of a power level sensor, an angular position sensor and, a rotation sensor.

24. A system according to claim 22, wherein said processor is configured to provide a first obstruction present control signal to said automatic power system control unit in response to said first obstruction present signal, said automatic power system control unit further configured to provide a motor cease operation signal to said motor in response to said first obstruction present control signal, said motor configured to control the positioning of said at least one of said automatic power roof system and automatic power windows system in response to said first obstruction present signal.

25. A method for automatically operating automatic power systems of an unattended automobile, said method comprising:
providing a damaging element detection sensor for detecting damaging element detection contacting an automobile surface, the damaging element detection sensor for providing a damaging element detection detected signal indicative of the level of the damaging element detection detected; and
providing a power control system configured to receive the damaging element detection signal, the power control system configured to automatically operate at least one of an automatic power windows or automatic power roof, the power control system operating the at least one of an automatic power windows or automatic power roof in response to said damaging element detection detected signal.

26. A method according to claim 25 further comprising:
providing a timer for providing a damaging element detection timing signal representative of the time duration during which no damaging element detection is detected by the damaging element detection sensor; and providing a database for storing at least one predetermined timing reference data.

27. A method according to claim 26 further comprising providing a processor for comparing the damaging element detection timing signal to at least one of said predetermined timing reference data, the processor configured to provide a control signal to the power control system.

28. A method according to claim 25 further comprising providing an obstruction sensor for detecting an obstruction impeding the operation of the power control system and sending an obstruction signal indicative of the obstruction to the processor.

29. A method according to claim 25 further comprising providing an occupant sensor for detecting an occupant in the cockpit of the automobile and sending an occupant present signal indicative of an occupant present in the cockpit to the processor.

30. A method for automatically operating automatic power systems of an unattended automobile, said method comprising:
providing a damaging element detection system sensor for detecting damaging element detection contacting an automobile surface and providing a damaging element detection signal; and
operating a power control system in accordance with a damaging element detection signal the power control system configured to automatically operate at least one of an automatic power windows or automatic power roof, the power control system operating the at least one of an automatic power windows or automatic power roof in response to said damaging element detection detected signal.

31. A method according to claim 30 further comprising providing an in-operation indicator for providing notice of the operation of the power control system, wherein the in-operation indicator provides at least one of audible and visual notification.

32. A method according to claim 31 further comprising providing notice of power control system operation at predetermined intervals.

33. A method according to claim 31 further comprising providing notification intermittently.

34. A system according to claim 1 further comprising an in-operation indicator for providing notification of automatic power system operation.

35. A system according to claim 34, wherein said notification is one of an audible notification and a visual notification.

36. A system according to claim 34 wherein said notification is provided at predetermined intervals.

37. A system according to claim 34, wherein said notification is provided intermittently.

38. A system according to claim 34, wherein said in-operation indicator comprises at least one of an automobile lighting system, automobile horn, and automobile alarm system.
